(19) United States
(12) Patent Application Publication
(10) Pub. No.: US 2018/0024707 A1
(43) Pub. Date: Jan. 25, 2018

(54) INFORMATION PROCESSING DEVICE AND SCREEN DISPLAY METHOD

(71) Applicant: KYOCERA Document Solutions Inc., Osaka (JP)

(72) Inventor: Ryosuke KATO, Osaka (JP)

(73) Assignee: KYOCERA Document Solutions Inc., Osaka (JP)

(21) Appl. No.: 15/549,338

(22) PCT Filed: Feb. 9, 2016
(86) PCT No.: PCT/JP2016/053841

§ 371 Date: Aug. 7, 2017

(30) Foreign Application Priority Data
Mar. 13, 2015 (JP) 2015-050667

(51) Int. Cl. G06F 3/0482; G06F 3/0488

(52) U.S. Cl. CPC G06F 3/0482; G06F 3/0488

(57) ABSTRACT

The present invention prevents erroneous operation of an operation screen by a user when an interruption notification screen is displayed on the operation screen. An information processing device is provided with: a display portion that can be operated by touch; a display control portion that displays, on the display portion, an operation screen in which a plurality of soft keys are arranged for inputting characters; a storage portion in which data indicating specific character strings likely to be input by a user is stored in advance; an interruption detection portion that detects the occurrence of an interruption; an interruption notification portion that displays an interruption notification screen for reporting the occurrence of an interruption on the operation screen in an overlaid manner when the occurrence of an interruption is detected by the interruption detection portion; and a prediction portion that uses the data indicating specific character strings to predict a first soft key corresponding to a character likely to be input next by the user among the plurality of soft keys. The interruption notification portion displays the interruption notification screen so that the first soft key predicted by the prediction portion is exposed.

### TECHNICAL FIELD

The present invention relates to an information processing device, a screen display method, and a control program, and relates particularly to a technique of displaying, on a touch-operable display portion, a screen for providing a notification of occurrence of an interruption.

### BACKGROUND ART

Conventionally, there is known a technique in which when an interruption has occurred in a case where an operation screen is being displayed on a touch-operable display portion, a screen for providing a notification of occurrence of said interruption and said operation screen are displayed at the same time on the display portion.

For example, Patent Document 1 below discloses that in a case where, while a single operation screen for performing an operation of a function is displayed, a request for an interruption by another function has occurred, said single operation screen is scaled down by half, and said scaled-down single operation screen and an operation screen for performing an operation of said another function are displayed at the same time.

Furthermore, Patent Document 2 below discloses that in a case where, while a setting screen for a job A is displayed, a command for an interruption by a job B has been inputted, identifiers for displaying the setting screen for the job A and a setting screen for the job B, respectively, are displayed so as to be selectable, and one of the selling screens that corresponds to a user-selected one of the identifiers is displayed.

### LIST OF CITATIONS

### Patent Literature

Patent Document 1: JP-A-2012-8726
Patent Document 2: JP-A-2008-241963

### SUMMARY OF INVENTION

### Technical Problem

The technique disclosed in Patent Document 1 above, however, has led to a fear that, in a case where an interruption has occurred when a user is in the middle of repeatedly performing an operation using an operation screen, the user might fail to notice that the operation screen has been scaled down and erroneously touch-operate a component for an unintended operation on the scaled-down operation screen. Furthermore, the technique disclosed in Patent Document 2 above has led to a fear that, after occurrence of an interruption, a user is required to take the trouble of performing an operation of selecting an identifier corresponding to a setting screen to be operated, thus being hindered from promptly performing an intended operation.

The present invention has been made to solve the above-described problems and has as its object to provide an information processing device, a screen display method, and a control program that are capable of preventing a user from erroneously operating an operation screen when an interruption notification screen is displayed on the operation screen.

### Solution to Problem

An information processing device according to one aspect of the present invention, which achieves the above-described object, is provided with a touch-operable display portion, a display control portion that displays, on the display portion, an operation screen in which a plurality of soft keys for inputting characters are arranged, a storage portion that pre-stores data indicating a particular character string highly likely to be inputted by a user, an interruption detection portion that detects occurrence of an interruption, an interruption notification portion that, when the occurrence of the interruption has been detected by the interruption detection portion, displays in an overlaid manner on the operation screen, an interruption notification screen for providing a notification of the occurrence of the interruption, and a prediction portion that predicts, by using the data indicating the particular character string, a first soft key corresponding to a character highly likely to be inputted next by the user among the plurality of soft keys. The interruption notification portion displays the interruption notification screen so that the first soft key predicted by the prediction portion is exposed.

Furthermore, a screen display method according to a second aspect of the present invention is a screen display method performed in an information processing device provided with a touch-operable display portion. The information processing device is further provided with a storage portion that pre-stores data indicating a particular character string highly likely to be inputted by a user. The method includes, through operating a computer of the information processing device, displaying, on the display portion, an operation screen in which a plurality of soft keys for inputting characters are arranged, detecting occurrence of an interruption, predicting, upon detection of the occurrence of the interruption, by using the data indicating the particular character string, a first soft key corresponding to a character highly likely to be inputted next by the user among the plurality of soft keys, and displaying in an overlaid manner on the operation screen, an interruption notification screen for providing a notification of the occurrence of the interruption so that said first soft key thus predicted is exposed.

Furthermore, a control program according to a third aspect of the present invention is a control program for operating a computer of an information processing device provided with a touch-operable display portion to function. The information processing device is further provided with a storage portion that pre-stores data indicating a particular character string highly likely to be inputted by a user. The program operates the computer of the information processing device to function as a display control portion that displays, on the display portion, an operation screen in which a plurality of soft keys for inputting characters are arranged, an interruption detection portion that detects occurrence of an interruption, an interruption notification portion that, when the occurrence of the interruption has been detected by the interruption detection portion, displays in an overlaid manner on the operation screen, an interruption notification screen for providing a notification of the occurrence of the interruption, and a prediction portion that predicts, by using the data indicating the particular character string, a first soft key corresponding to a character highly likely to be inputted next by the user among the plurality of soft keys. The interruption notification portion displays the interruption notification screen so that the first soft key predicted by the prediction portion is exposed.

According to this configuration, when the interruption notification screen is displayed in a case where the operation screen is being displayed on the touch-operable display portion, with respect to the first soft key corresponding to a character highly likely to be inputted next by a user among the plurality of soft keys displayed in the operation screen, the interruption notification screen is displayed at a position other than a position of the first soft key so that the first soft key is exposed. This can prevent the first soft key from being hidden by the interruption notification screen. As a result, the user can promptly touch-operate, without making an error, the first soft key highly likely to be touch-operated next among the plurality of soft keys displayed in the operation screen.

### Advantageous Effects of Invention

According to this invention, when the interruption notification screen is displayed on the operation screen, a user can be prevented from erroneously operating the operation screen.

### BRIEF DESCRIPTION OF DRAWINGS

FIG. 1 is a block diagram showing an electrical configuration of a portable device according to one embodiment of an information processing device of the present invention.

FIG. 2 is a diagram showing one example of a lock release screen according to one embodiment of an operation screen of the present invention.

FIG. 3 is a diagram showing one example of data indicating a password according to one embodiment of data indicating a particular character string of the present invention.

FIG. 4 is a diagram showing one example of a display mode of a mail reception notification screen according to one embodiment of an interruption notification screen of the present invention in a case where a first soft key has not been predicted.

FIG. 5 is a diagram showing one example of a display mode of the mail reception notification screen in a case where the first soft key has been predicted.

FIG. 6 is a flow chart showing an operation of releasing a locked state of the portable device.

FIG. 7 is a diagram showing one example of a display mode of the mail reception notification screen in a case where the first soft key and a second soft key have been predicted.

### DESCRIPTION OF EMBODIMENTS

Based on the appended drawings, the following describes one embodiment of an information processing device, a screen display method, and a control program according to the present invention. In this embodiment, as an information processing device, a portable device such as a smart phone or a tablet computer is used for the description with no intention of limiting the information processing device according to the present invention thereto. The information processing device according to the present invention may be, for example, an image forming device such as a facsimile device, a copy machine, a printer, or a multi-functional peripheral or an electronic device provided with a touch-operable display portion, such as a car navigation system or a personal computer.

FIG. 1 is a block diagram showing an electrical configuration of a portable device 1 according to one embodiment of the information processing device of the present invention. As shown in FIG. 1, the portable device 1 is provided with an operation display portion 20, a communication portion 30, a storage portion 40, and a control portion 10.

The operation display portion 20 is provided with a touch-operable display portion 21 such as a liquid crystal display having a touch panel function and a start-up button 22 for starting up the portable device 1.

The communication portion 30 is formed of a wireless communication module and performs wireless communication via a network such as a public telephone network or the Internet. For example, the communication portion 30 receives data indicating an email reception notification transmitted by a mail server.

The storage portion 40 is a non-volatile memory such as a flash memory. In the storage portion 40, as will be mentioned later, there are pre-stored various types of data necessary for an operation of the portable device 1, such as data indicating a password (a particular character string) formed of a four-digit number, which needs to be inputted in order to release a locked state of the portable device 1.

The control portion 10 is a microcomputer (a computer) provided with an unshown CPU (central processing unit) that executes prescribed arithmetic processing, an unshown non-volatile memory, such as an EEPROM (electrically erasable and programmable read only memory), in which a prescribed control program is stored, an unshown RAM (random access memory) for temporarily storing data, their peripheral circuits, and so on. The control portion 10 controls the CPU to execute the control program stored in the above-described non-volatile memory and thus controls operations of the various portions in the portable device 1.

For example, in a case where the start-up button 22 is pressed while the portable device 1 is starting up, the control portion 10 brings the portable device 1 to a locked state. A locked state refers to a state where the portable device 1 is prohibited from being operated by a touch operation on the display portion 21. Furthermore, the control portion 10 relates to an operation of releasing a locked state of the portable device 10 and particularly functions as a display control portion 11, a prediction portion 12, an interruption detection portion 13, and an interruption notification portion 14.

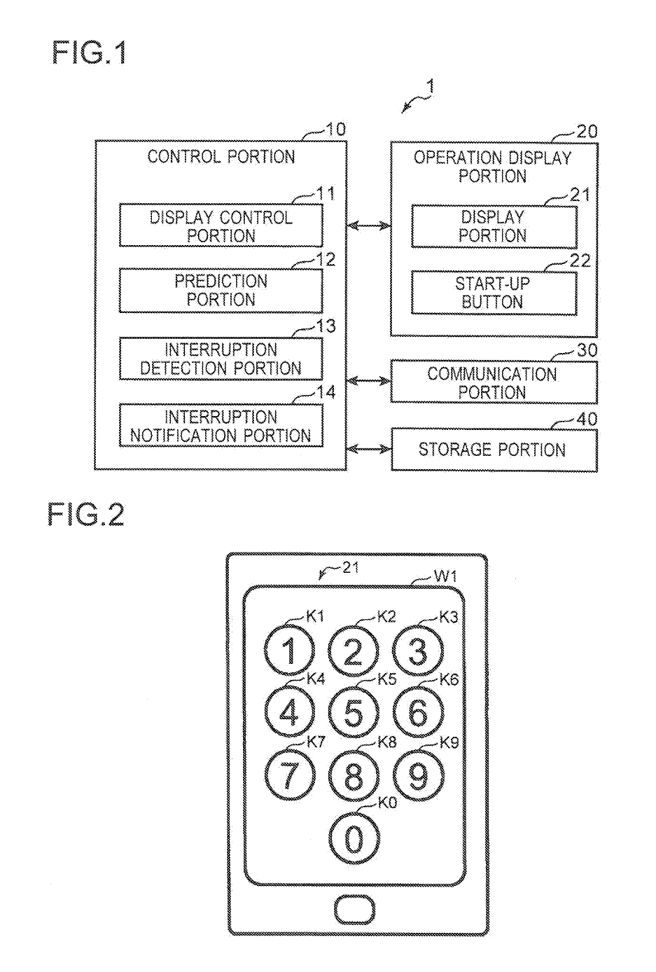

In a case where the start-up button 22 is pressed when the portable device 1 is in a locked state, the display control portion 11 displays a lock release screen W1 shown in FIG. 2 on the display portion 21. FIG. 2 is a diagram showing one example of the lock release screen W1 according to one embodiment of an operation screen of the present invention.

As shown in FIG. 2, in the lock release screen W1, ten soft keys K0 to K9 for inputting ten numerals “0” to “9”, respectively, are arranged. On the lock release screen W1, a touch operation with respect to any one of the ten soft keys K0 to K9 is performed four times, and thus a four-digit number can be inputted. In a case where a four-digit number inputted by using the lock release screen W1 matches a four-digit number indicated by the above-described password, the control portion 10 releases a locked state of the portable device 1.

As described above, a password is a character string that is inputted by using the lock release screen W1 every time a user releases a locked state of the portable device 1, thus representing a character string highly likely to be inputted by the user by using the lock release screen W1.

The prediction portion 12 predicts, by using the data indicating a password stored in the storage portion 40, a first soft key corresponding to a character highly likely to be inputted next by a user among the ten soft keys K0 to K9 in the lock release screen W1.

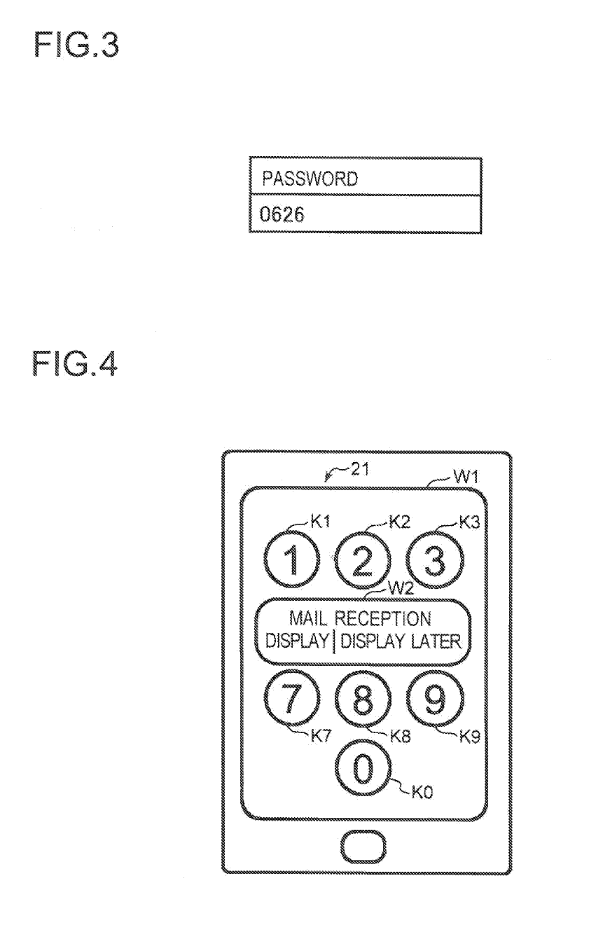

FIG. 3 is a diagram showing one example of data indicating a password according to one embodiment of data indicating a particular character string of the present invention. For example, as shown in FIG. 3, it is assumed that data indicating a password “0626” is pre-stored in the storage portion 40. In this case, when none of the ten soft keys K0 to K9 in the lock release screen W1 has been touch-operated, the soft key K0 corresponding to a first character “0” of the password is predicted as the first soft key corresponding to a character highly likely to be inputted next by a user.

Meanwhile, it is assumed that a user has sequentially touch-operated the soft key K0 and the soft key K6, thus inputting an input character string “06” formed of a two-digit number. In this case, the prediction portion 12 judges that the input character string “06” matches a partial character string “06” starting from the first character “0” in the password. Then, the prediction portion 12 predicts, as the first soft key, the soft key K2 corresponding to a character “2” following a last character “6” of the above-described partial character string “06” in the password.

It is now assumed that a user has sequentially touch-operated the soft key K5 and the soft key K6, thus inputting an input character string “56”. In this case, since the input character string “56” does not match the partial character string “06” starting from the first character “0” in the password, the prediction portion 12 judges that the user is inputting a four-digit number different from the password. In this case, the prediction portion 12 is unable to predict, by using the password, a character highly likely to be inputted next by the user and thus does not predict the first soft key.

The interruption detection portion 13 detects occurrence of an interruption. Specifically, in a case where the lock release screen W1 is being displayed on the display portion 21, upon reception of the above-described data indicating an email reception notification by the communication portion 30, the interruption detection portion 13 recognizes that an interruption to the lock release screen W1 by an external data input has occurred, thus detecting occurrence of said interruption.

When occurrence of an interruption has been detected by the interruption detection portion 13, the interruption notification portion 14 displays, in an overlaid manner on the lock release screen W1, a mail reception notification screen (an interruption notification screen) for providing a notification of occurrence of said interruption. In a case where the first soft key has not been predicted by the prediction portion 12, the interruption notification portion 14 displays the mail reception notification screen at a prescribed position, while in a case where the first soft key has been predicted by the prediction portion 12, the interruption notification portion 14 displays the mail reception notification screen so that the first soft key is exposed.

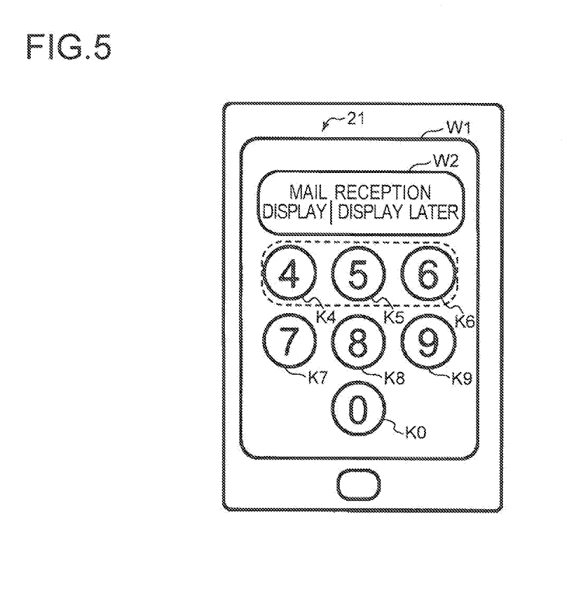

FIG. 4 is a diagram showing one example of a display mode of a mail reception notification screen W2 according to one embodiment of an interruption notification screen of the present invention in a case where the first soft key has not been predicted. FIG. 5 is a diagram showing one example of a display mode of the mail reception notification screen W2 in a case where the first soft key has been predicted.

For example, in a case where the first soft key has not been predicted, as shown in FIG. 4, at a prescribed position preset as a position where the soft keys K4 to K6 are arranged, the interruption notification portion 14 displays the mail reception notification screen W2 in an overlaid manner on the lock release screen W1.

Meanwhile, for example, it is assumed that the soft key K6 has been predicted as the first soft key by the prediction portion 12. In this case, as shown in FIG. 5, in place of the above-described prescribed position (a dotted area in FIG. 5), at a position where the soft keys K1 to K3 are arranged, the interruption notification portion 14 displays the mail reception notification screen W2 in an overlaid manner on the lock release screen W1 so that the soft key K6 predicted as the first soft key is exposed.

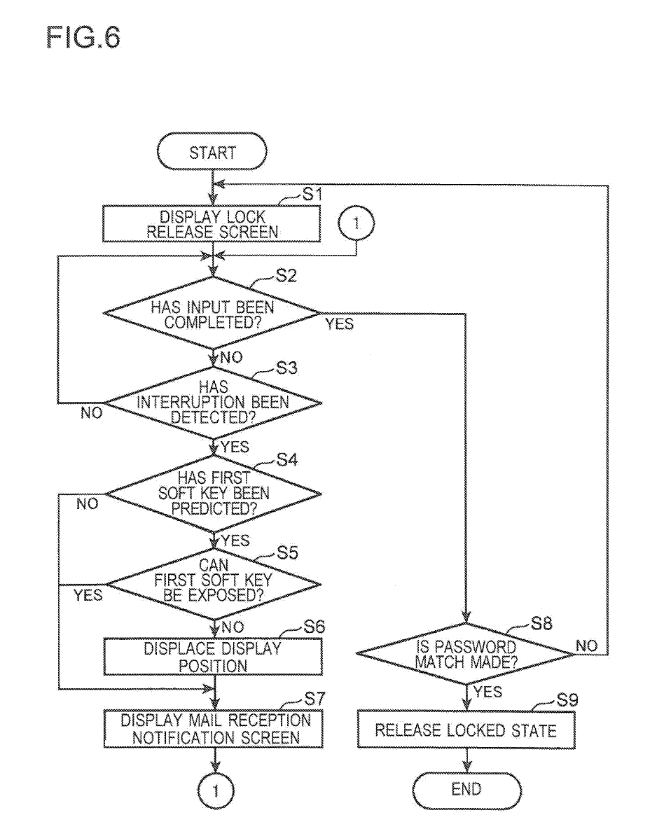

The following describes an operation of releasing a locked state of the portable device 1, which is performed by the control portion 10. FIG. 6 is a flow chart showing the operation of releasing a locked state of the portable device 1. In a case where the start-up button 22 is pressed when the portable device 1 is in a locked state, the display control portion 11 displays the lock release screen W1 on the display portion 21 (S1).

Further, in a case where an input of a four-digit number using the ten soft keys K0 to K9 in the lock release screen W1 has not been completed (S2; NO), it is determined that the interruption detection portion 13 has detected occurrence of an interruption (S3; YES).

In this case, as mentioned above, the prediction portion 12 predicts the first soft key by using the data indicating a password stored in the storage portion 40 (S4).

In a case where the first soft key has been predicted by the prediction portion 12 (S4; YES), the interruption notification portion 14 determines whether or not said first soft key thus predicted would be exposed, supposing that the mail reception notification screen W2 is displayed at the above-described prescribed position (S5).

For example, it is assumed that, at Step S4, the prediction portion 12 has predicted the soft key K0 as the first soft key. In this case, at Step S5, the interruption notification portion 14 determines that, as shown in FIG. 4, the soft key K0 as the first soft key would be exposed, supposing that the mail reception notification screen W2 is displayed at the above-described prescribed position (the position where the soft keys K4 to K6 are arranged) (S5; YES). In this case, as shown in FIG. 4, at the above-described prescribed position, the interruption notification portion 14 displays the mail reception notification screen W2 in an overlaid manner on the lock release screen W1 (S7).

Meanwhile, it is assumed that, at Step S4, the prediction portion 12 has predicted the soft key K6 as the first soft key. In this case, at Step S5, the interruption notification portion 14 determines that, as shown in FIG. 5, the soft key K6 as the first soft key would not be exposed, supposing that the mail reception notification screen W2 is displayed at the above-described prescribed position (the position where the soft keys K4 to K6 are arranged, the dotted area in FIG. 5) (S5; NO).

In this case, as shown in FIG. 5, the interruption notification portion 14 displaces a display position of the mail reception notification screen W2 from the above-described prescribed position to a position where the soft keys K1 to K3 are arranged so that the soft key K6 as the first soft key is exposed (S6). Then, at the display position displaced at Step S6, the interruption notification portion 14 displays the mail reception notification screen W2 in an overlaid manner on the lock release screen W1 (S7).

In a case where, at Step S4, the first soft key has not been predicted by the prediction portion 12 (S4; NO), as shown in FIG. 4, at the above-described prescribed position (the position where the soft keys K4 to K6 are arranged), the interruption notification portion 14 displays the mail reception notification screen W2 in an overlaid manner on the lock release screen W1 (S7).

After execution of Step S7, process steps of Step S2 and the subsequent steps are repeatedly performed.

In a case where, after execution of Step S7, a user has moved the mail reception notification screen W2 while maintaining a touch thereon, the interruption notification portion 14 displays the mail reception notification screen W2 at a position to which the user has thus moved the mail reception notification screen W2. That is, the mail reception notification screen W2 is configured to be movable by a so-called swiping operation by a user. Thus, a user can continue to perform an operation on the lock release screen W1 while the mail reception notification screen W2 is displayed.

Furthermore, in a case where, after execution of Step S7, a user has touch-operated the mail reception notification screen W2 twice consecutively, the interruption notification portion 14 stops displaying the mail reception notification screen W2. That is, the mail reception notification screen W2 is configured to be stopped from being displayed by a so-called double tapping operation by a user. Thus, a user can efficiently continue to perform an operation on the lock release screen W1 by stopping displaying the mail reception notification screen W2.

After that, in a case where an input of a four-digit number using the ten soft keys K0 to K9 in the lock release screen W1 has been completed (S2; YES), the control portion 10 determines whether or not said four-digit number thus inputted matches the above-described password (S8).

In a case where, at Step S8, the control portion 10 has determined that the inputted four-digit number matches a four-digit number indicated by the above-described password (S8; YES), the control portion 10 executes a prescribed process step for releasing a locked state of the portable device 1 (S9). In said prescribed process step, the display control portion 11 stops displaying the lock release screen W1 and displays, on the display portion 21, a home screen preset as a screen to be displayed after a release of a locked state.

Meanwhile, in a case where, at Step S8, the control portion 10 has determined that the inputted four-digit number does not match the four-digit number indicated by the above-described password (S8; NO), the control portion 10 displays, on the display portion 21, a warning message to the effect that the inputted four-digit number does not match the password. After that, process steps of Step S1 and the subsequent steps are repeatedly performed.

As described above, according to the configuration of the foregoing embodiment, when the mail reception notification screen W2 is displayed in a case where the lock release screen W1 is being displayed on the touch-operable display portion 21, with respect to the first soft key corresponding to a character highly likely to be inputted nest by a user among the ten soft keys K0 to K9 displayed in the lock release screen W1, the mail reception notification screen W2 is displayed at a position other than a position of the first soft key so that the first soft key is exposed. This can prevent the first soft key from being hidden by the mail reception notification screen W2. As a result, a user can promptly touch-operate, without making an error, the first soft key highly likely to be touch-operated next among the ten soft keys K0 to K9 displayed in the lock release screen W1.

Furthermore, when the mail reception notification screen W2 is displayed in a case where none of the ten soft keys K0 to K9 has been operated, one of the soft keys K0 to K9 that corresponds to a character indicated by a first character of a password is predicted as the first soft key, and thus the soft key for inputting the first character can be prevented from being hidden by the mail reception notification screen W2. Thus, a user can promptly touch-operate, without making an error, a soft key corresponding to a character highly likely to be inputted first, which is indicated by the first character of the password.

Furthermore, it is assumed that the mail reception notification screen W2 is displayed in a case where a user has touch-operated any of the ten soft keys K0 to K9, thus inputting a character string corresponding to a partial character string starting from a first character in a password. In this case, according to the configuration of the foregoing embodiment, one of the soft keys K0 to K9 that corresponds to a character following a last character of the above-described partial character string is predicted as the first soft key, and thus the soft key for inputting the character following the last character can be prevented from being hidden by the mail reception notification screen W2. Thus, a user can promptly touch-operate, without making an error, a soft key corresponding to a character highly likely to be inputted next, which is indicated by the character following the last character of the above-described character string.

The foregoing embodiment is merely illustrative of embodiments according to the present invention and not intended to limit the present invention to the foregoing embodiment. For example, following modification embodiments may also be adopted.

(1) By using the above-described data indicating a password (the particular character string), the prediction portion 12 may further predict a second soft key corresponding to a character highly likely to be inputted by a user after inputting a character to be inputted next among the ten soft keys K0 to K9. Correspondingly therewith, in a case where the first soft key and the second soft key have been predicted by said prediction portion 12, the interruption notification portion 14 may display the mail reception notification screen W2 (the interruption notification screen) so that said first and second soft keys thus predicted are exposed.

Specifically, it is assumed that, as shown in FIG. 3, data indicating a password “0626” formed of a four-digit number is pre-stored in the storage portion 40. In this case, when, at Step S4, none of the ten soft keys K0 to K9 in the lock release screen W1 has not been touch-operated, as mentioned above, the prediction portion 12 of Modification Embodiment (1) predicts, as the first soft key, the soft key K0 corresponding to a first character “0” of the password. Moreover, said prediction portion 12 predicts, as the second soft key, the soft key K6 corresponding to a character “6” following the first character “0” in the password.

Meanwhile, it is assumed that a user has touch-operated the soft key K0 and the soft key K6, thus inputting an input character string “06” formed of a two-digit number. In this case, at Step S4, as mentioned above, said prediction portion 12 judges that said input character string “06” matches a partial character string “06” starting from the first character “0” in the password. Then, said prediction portion 12 predicts, as the first soft key, the soft key K2 corresponding to a character “2” following a last character “6” of said partial character string “06” in the password. Moreover, said prediction portion 12 predicts, as the second soft key, the soft key K6 corresponding to a character “6” that follows the character following the last character “6” of said partial character string “06” in the password.

Furthermore, it is assumed that a user has sequentially touch-operated the soft key K0, the soft key K6, and the soft key K2, thus inputting an input character string “062” formed of a three-digit number. In this case, at Step S4, said prediction portion 12 judges that said input character string “062” matches a partial character string “062” starting from the first character “0” in the password. Then, the prediction portion 12 predicts, as the first soft key, the soft key K6 corresponding to a character “6” following a last character “2” of the above-described partial character string “062”. In this case, however, there exists no character that follows the character following the last character “2” of the above-described partial character string “062” in the password, and thus the said prediction portion 12 does not predict the second soft key.

Correspondingly therewith, in a case where the first soft key and the second soft key have been predicted at Step S4 of Modification Embodiment (1), at Step S5, the interruption notification portion 14 of Modification Embodiment (1) determines whether or not said first and second soft keys thus predicted would be exposed, supposing that the mail reception notification screen W2 is displayed at the above-described prescribed position.

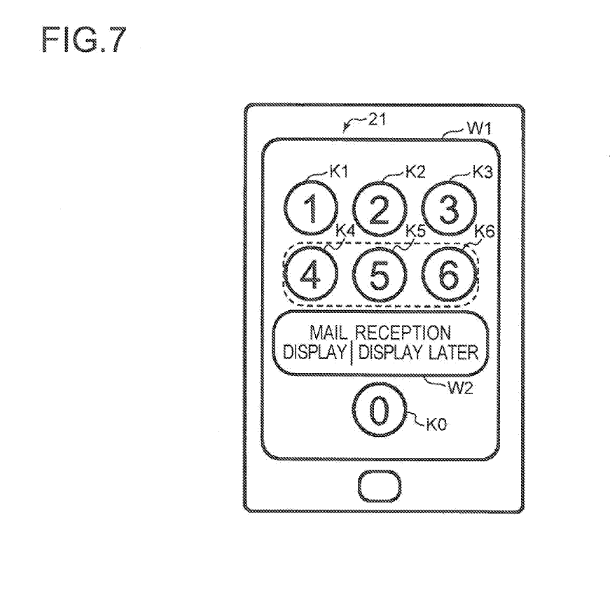

FIG. 7 is a diagram showing one example of a display mode of the mail reception notification screen W2 in a case where the first soft key and the second soft key have been predicted by the prediction portion 12. For example, it is assumed that, at Step S4 of Modification Embodiment (1), the prediction portion 12 has predicted the soft key K2 as the first soft key and the soft key K6 as the second soft key.

In this case, at Step S5 of Modification Embodiment (1), the interruption notification portion 14 determines that, as show in FIG. 7, supposing that the mail reception notification screen W2 is displayed at the above-described prescribed position (the position where the soft keys K4 to K6 are arranged, a dotted area in FIG. 7), while the soft key K2 as the first soft key would be exposed, the soft key K6 as the second soft key would not be exposed (S5; NO).

In this case, at Step S6 of Modification Embodiment (1), the interruption notification portion 14 displaces a display position of the mail reception notification screen W2 from the above-described prescribed position to a position where the soft keys K7 to K9 are arranged so that, as shown in FIG. 7, the soft key K2 as the first soft key and the soft key K6 as the second soft key are exposed. Then, at Step S7, as shown in FIG. 7, at the display position displaced at said Step S6, the interruption notification portion 14 displays the mail reception notification screen W2 in an overlaid manner on the lock release screen W1.

Meanwhile, it is assumed that, at Step S4 of Modification Embodiment (1), the prediction portion 12 has predicted the soft key K2 as the first soft key and the soft key K9 as the second soft key. In this case, at Step S5 of Modification Embodiment (1), the interruption notification portion 14 determines that, as shown in FIG. 4, supposing that the mail reception notification screen W2 is displayed at the above-described prescribed position (the position where the soft keys K4 to K6 are arranged), the soft key K2 as the first soft key and the soft key K9 as the second soft key would be exposed (S5; YES). In this case, at Step S7, as shown in FIG. 4, at the above-described prescribed position, the interruption notification portion 14 displays the mail reception notification screen W2 in an overlaid manner on the lock release screen W1.

Furthermore, in a case where, at Step S4 of Modification Embodiment (1), while the first soft key has been predicted by the prediction portion 12, the second soft key has not been predicted thereby, the interruption notification portion 14 of Modification Embodiment (1) performs the same process steps as those of Steps S5 and S6 described in the foregoing embodiment.

According to the configuration of Modification Embodiment (1), with respect to the first soft key corresponding to a character highly likely to be inputted next by a user and the second soft key corresponding to a character highly likely to be inputted by the user after inputting the character to be inputted next, the mail reception notification screen W2 is displayed at a position other than positions of the first soft key and the second soft key so that the first soft key and the second soft key are exposed. This can prevent the first soft key and the second soft key from being hidden by the mail reception notification screen W2. As a result, a user can promptly and consecutively touch-operate, without making an error, two soft keys highly likely to be consecutively touch-operated next among the ten soft keys K0 to K9 displayed in the lock release screen W1.

Furthermore, when the mail reception notification screen W2 is displayed in a case where none of the ten soft keys K0 to K9 has been operated, one of the ten soft keys K0 to K9 that corresponds to a character indicated by a first character of a password is predicted as the first soft key, and another one of the ten soft keys K0 to K9 that corresponds to a character following the first character in the password is predicted as the second soft key. This can prevent a soft key for inputting a character indicated by a first character of a password and another soft key for inputting a character following the first character from being hidden by the mail reception notification screen W2. Thus, a user can promptly and consecutively touch-operate, without making an error, a soft key corresponding to a character highly likely to be inputted first, which is indicated by a first character of a password, and another soft key corresponding to a character highly likely to be inputted after inputting that character.

Furthermore, it is assumed that the mail reception notification screen W2 is displayed in a case where a user has touch-operated any of the ten soft keys K0 to K9, thus inputting a character string matching a partial character string starting from a first character in a password. In this case, according to the configuration of Modification Embodiment (1), a soft key corresponding to a character following a last character of the above-described partial character string is predicted as the first soft key, and another soft key corresponding to a character that follows the character following the last character of the above-described partial character string is predicted as the second soft key. This can prevent the soft key for inputting the character following the last character and the soft key for inputting the character that follows the character following the last character from being hidden by the mail reception notification screen W2. Thus, a user can promptly and consecutively touch-operate, without making an error, a soft key corresponding to a character highly likely to be inputted next, which is indicated by the character following the last character of the above-described partial character string, and a soft key corresponding to a character highly likely to be inputted after inputting that character.

(2) The display control portion 11 may display, on the display portion 21, in place of the above-mentioned lock release screen W1, another operation screen in which a plurality of soft keys for inputting characters are arranged. Correspondingly thereto, in place the above-mentioned password, data indicating a particular character string highly likely to be inputted by a user by using said another operation screen may be pre-stored in the storage portion 40. Then, by using said particular character string, the prediction portion 12 may predict the first soft key (and the second soft key) by a method similar to the above-mentioned method.

(3) In a case where the portable device 1 is a device used by a plurality of users, passwords corresponding to the users, respectively, may be pre-stored in the storage portion 40. Correspondingly thereto, the control portion 10 may perform control so that passwords inputted by using the lock release screen W1 in the prescribed process step for releasing a locked state of the portable device 1 at Step S9 and a cumulative number of times said passwords have inputted are pre-stored in association with each other in the storage portion 40. Then, by using one of the passwords that is stored in association with a highest value of the cumulative number, the prediction portion 12 may predict the first soft key (and the second soft key) by a method similar to the above-mentioned method.

(4) The operation screen of the present invention is not limited to the lock release screen W1. Furthermore, occurrence of an interruption referred to in the present invention is not limited to a phenomenon that data indicating an email reception notification is received by the communication portion 30. Furthermore, the interruption notification screen of the present invention is not limited to the mail reception notification screen W2 that provides a notification of the phenomenon that data indicating an email reception notification is received by the communication portion 30.

For example, the portable device 1 may have a function in which, as in a well-known alarm function provided in an electronic device such as a smart phone or a tablet computer, while a certain first operation screen in which a plurality of soft keys are arranged is displayed, at prescribed timing, a second operation screen different from the first operation screen is displayed in an overlaid manner on the first operation screen. In this case, a configuration may be adopted in which the display control portion 11 displays the first operation screen in place of the lock release screen W1, and the interruption detection portion 13 detects occurrence of an interruption when the above-described prescribed timing has been reached. Then, when said occurrence of an interruption is detected by the interruption detection portion 13, the interruption notification portion 14 may display the second operation screen in place of the mail reception notification screen W2.

As described above, the information processing device (the portable device 1) according to the present invention is provided with the touch-operable display portion 21, the display control portion 11 that displays, on the display portion 21, the operation screen (the lock release screen W1) in which the plurality of soft keys K0 to K9 for inputting characters are arranged, the storage portion 40 that pre-stores data indicating a particular character string highly likely to be inputted by a user, the interruption detection portion 13 that detects occurrence of an interruption, the interruption notification portion 14 that, when the occurrence of the interruption has been detected by the interruption detection portion 13, displays in an overlaid manner on the operation screen, the interruption notification screen (the mail reception notification screen W2) for providing a notification of the occurrence of the interruption, and the prediction portion 12 that predicts, by using the data indicating the particular character string, a first soft key corresponding to a character highly likely to be inputted next by the user among the plurality of soft keys K0 to K9. The interruption notification portion 14 displays the interruption notification screen so that the first soft key predicted by the prediction portion 12 is exposed.

According to this configuration, when the interruption notification screen is displayed in a case where the operation screen is being displayed on the touch-operable display portion 21, with respect to the first soft key corresponding to a character highly to be inputted next by a user among the plurality of soft keys K0 to K9 displayed in the operation screen, the interruption notification screen is displayed at a position other than a position of the first soft key so that the first soft key is exposed. This can prevent the first soft key from being hidden by the interruption notification screen. As a result, a user can promptly touch-operate, without making an error, the first soft key highly likely to be touch-operated next among the plurality of soft keys displayed in the operation screen.

Furthermore, preferably, in a case where none of the plurality of soft keys K0 to K9 has been touch-operated, the prediction portion 12 predicts, as the first soft key, one of the plurality of soft keys K0 to K9 that corresponds to a first character of the particular character string.

According to this configuration, when the interruption notification screen is displayed in a case where none of the plurality of soft keys K0 to K9 has been operated, one of the plurality of soft keys K0 to K9 that corresponds to a character indicated by a first character of a particular character string is predicted as the first soft key, and thus the soft key for inputting the first character is prevented from being hidden by the interruption notification screen. Thus, a user can promptly touch-operate, without making an error, a soft key corresponding to a character highly likely to be inputted first, which is indicated by a first character of a particular character string.

Furthermore, preferably, in a case where an input character string inputted by a touch operation with respect to the plurality of soft keys K0 to K9 matches a partial character string starting from a first character in the particular character string, the prediction portion 12 predicts, as the first soft key, one of the plurality of soft keys K0 to K9 that corresponds to a character following a last character of the partial character string in the particular character string.

It is assumed that the interruption notification screen is displayed in a case where a user has touch-operated any of the plurality of soft keys K0 to K9, thus inputting a character string matching a partial character string starting from a first character in the particular character string. In this case, according to this configuration, one of the plurality of soft keys K0 to K9 that corresponds to a character following a last character of the above-described partial character string is predicted as the first soft key, and thus the soft key for inputting the character following the last character is prevented from being hidden by the interruption notification screen. Thus, a user can promptly touch-operate, without making an error, a soft key corresponding to a character highly likely to be inputted next, which is indicated by the character following the last character of the above-described partial character string.

Furthermore, preferably, by using the data indicating the particular character string, the prediction portion 12 further predicts a second soft key corresponding to a character highly likely to be inputted by a user after inputting a character to be inputted next among the plurality of soft keys K0 to K9, and the interruption notification portion 14 displays the interruption notification screen so that the first soft key and the second soft key thus predicted by the prediction portion 12 are exposed.

According to this configuration, with respect to the first soft key corresponding to a character highly likely to be inputted next by a user and the second soft key corresponding to a character highly likely to be inputted by the user after inputting the character to be inputted next, the interruption notification screen is displayed at a position other than positions of the first soft key and the second soft key so that the first soft key and the second soft key are exposed. This can prevent the first soft key and the second soft key from being hidden by the interruption notification screen. As a result, a user can promptly and consecutively touch-operate, without making an error, two soft keys highly likely to be consecutively touch-operated next among a plurality of soft keys displayed in an operation screen.

Furthermore, preferably, in a case where none of the plurality of soft keys K0 to K9 has been touch-operated, the prediction portion 12 predicts, as the first soft key, one of the plurality of soft keys K0 to K9 that corresponds to a first character in the particular character string and, as the second soft key, another one of the plurality of soft keys K0 to K9 that corresponds to a character following the first character in the particular character string.

According to this configuration, when the interruption notification screen is displayed in a case where none of the plurality of soft keys K0 to K9 has been operated, one of the plurality of soft keys K0 to K9 that corresponds to a character indicated by a first character in the particular character string is predicted as the first soft key, and another one of the plurality of soft keys K0 to K9 that corresponds to a character following the first character in the particular character string is predicted as the second soft key. This can prevent a soft key for inputting a character indicated by a first character of the particular character string and another soft key for inputting a character following the first character from being hidden by the interruption notification screen. Thus, a user can promptly and consecutively touch-operate, without making an error, a soft key corresponding to a character highly likely to be inputted first, which is indicated by a first character of the particular character string, and another soft key corresponding to a character highly likely to be inputted after inputting that character.

Furthermore, preferably, in a case where an input character string inputted by a touch operation with respect to the plurality of soft keys K0 to K9 matches a partial character string starting from a first character in the particular character string, the prediction portion 12 predicts, as the first soft key, one of the plurality of soft keys K0 to K9 that corresponds to a character following a last character of the partial character string in the particular character string and, as the second soft key, another one of the plurality of soft keys K0 to K9 that corresponds to a character that follows the character following the last character of the partial character string in the particular character string.

It is assumed that the interruption notification screen is displayed in a case where a user has touch-operated any of the plurality of soft keys K0 to K9, thus inputting a character string matching a partial character string starting from a first character in a particular character string. In this case, according to this configuration, one of the plurality of soft keys K0 to K9 that corresponds to a character following a last character of the above-described partial character string is predicted as the first soft key, and another one of the plurality of soft keys K0 to K9 that corresponds to a character that follows the character following the last character of the above-described partial character string is predicted as the second soft key. This can prevent the soft key for inputting the character following the last character and the soft key for inputting the character that follows the character following the last character from being hidden by the interruption notification screen. Thus, a user can promptly and consecutively touch-operate, without making an error, a soft key corresponding to a character highly likely to be inputted next, which is indicated by the character following the last character of the above-described partial character string, and a soft key corresponding to a character highly likely to be inputted after inputting that character.

1. An information processing device, comprising:
a touch-operable display portion;
a display control portion that displays, on the display portion, an operation screen in which a plurality of soft keys for inputting characters are arranged;
a storage portion that pre-stores data indicating a particular character string highly likely to be inputted by a user;
an interruption detection portion that detects occurrence of an interruption;
an interruption notification portion that, when the occurrence of the interruption has been detected by the interruption detection portion, displays in an overlaid manner on the operation screen, an interruption notification screen for providing a notification of the occurrence of the interruption; and
a prediction portion that predicts, by using the data indicating the particular character string, a first soft key corresponding to a character highly likely to be inputted next by the user among the plurality of soft keys,
wherein
the interruption notification portion displays the interruption notification screen so that the first soft key predicted by the prediction portion is exposed.

2. The information processing device according to claim 1, wherein
in a case where none of the plurality of soft keys has been touch-operated, the prediction portion predicts, as the first soft key, one of the plurality of soft keys that corresponds to a first character of the particular character string.

3. The information processing device according to claim 1, wherein
in a case where an input character string inputted by a touch operation with respect to the plurality of soft keys matches a partial character string starting from a first character in the particular character string, the prediction portion predicts, as the first soft key, one of the plurality of soft keys that corresponds to a character following a last character of the partial character string in the particular character string.

4. The information processing device according to claim 2, wherein
in a case where an input character string inputted by a touch operation with respect to the plurality of soft keys matches a partial character string starting from the first character in the particular character string, the prediction portion predicts, as the first soft key, one of the plurality of soft keys that corresponds to a character following a last character of the partial character string in the particular character string.

5. The information processing device according to claim 1, wherein
by using the data indicating the particular character string, the prediction portion further predicts a second soft key corresponding to a character highly likely to be inputted by a user after inputting a character to be inputted next among the plurality of soft keys, and
the interruption notification portion displays the interruption notification screen so that the first soft key and the second soft key thus predicted by the prediction portion are exposed.

6. The information processing device according to claim 5, wherein
in a case where none of the plurality of soft keys has been touch-operated, the prediction portion predicts, as the first soft key, one of the plurality of soft keys that corresponds to a first character in the particular character string and, as the second soft key, another one of the plurality of soft keys that corresponds to a character following the first character in the particular character string.

7. The information processing device according to claim 5, wherein
in a case where an input character string inputted by a touch operation with respect to the plurality of soft keys matches a partial character string starting from a first character in the particular character string, the prediction portion predicts, as the first soft key, one of the plurality of soft keys that corresponds to a character following a last character of the partial character string in the particular character string and, as the second soft key, another one of the plurality of soft keys that corresponds to a character that follows the character following the last character of the partial character string in the particular character string.

8. The information processing device according to claim 6, wherein
in a case where an input character string inputted by a touch operation with respect to the plurality of soft keys matches a partial character string starting from the first character in the particular character string, the prediction portion predicts, as the first soft key, one of the plurality of soft keys that corresponds to a character following a last character of the partial character string in the particular character string and, as the second soft key, another one of the plurality of soft keys that corresponds to a character that follows the character following the last character of the partial character string in the particular character string.

9. A screen display method performed in an information processing device comprising a touch-operable display portion, the information processing device further comprising a storage portion that pre-stores data indicating a particular character string highly likely to be inputted by a user, the method comprising steps of:
through operating a computer of the information processing device,
displaying, on the display portion, an operation screen in which a plurality of soft keys for inputting characters are arranged;
detecting occurrence of an interruption;
predicting, upon detection of the occurrence of the interruption, by using the data indicating the particular character string, a first soft key corresponding to a character highly likely to be inputted next by the user among the plurality of soft keys; and
displaying in an overlaid manner on the operation screen, an interruption notification screen for providing a notification of the occurrence of the interruption so that said first soft key thus predicted is exposed.

10. (canceled)
